(19) United States
(12) Patent Application Publication
(10) Pub. No.: US 2009/0153880 A1
(43) Pub. Date: Jun. 18, 2009

(54) OPTICAL SYSTEM FOR DETECTING MOTION OF A BODY

(75) Inventors: Renatus Gerardus Klaver, Eindhoven (NL); Johan Cornelis Compter, Eindhoven (NL); Piet Van Der Meer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,561

(22) PCT Filed: Nov. 16, 2005
(86) PCT No.: PCT/IB05/53790

§ 371 Date: May 17, 2007

(30) Foreign Application Priority Data
Nov. 22, 2004 (EP) 04105956.9

(51) Int. Cl. G01B 11/00

(52) U.S. Cl. 356/614

(57) ABSTRACT

The invention relates to a system (1) for detecting motion of a body (2), said body comprising a first diffraction pattern (3A) and a second diffraction pattern (3B) with a predetermined orientation relative to said first diffraction pattern. The system comprises optical means (4A, 4B) adapted to provide at least a first incident beam to said first diffraction pattern to obtain a first diffracted beam from said first diffraction pattern and at least a second incident beam, with a predetermined orientation relative to said first incident beam, to said second diffraction pattern to obtain a second diffracted beam from said second diffraction pattern. The system has means for detecting motion of said body on the basis of the phase difference between at least one of said first diffracted beam and said second diffracted beam. Accordingly a larger in-plane rotation range is obtained for detecting motion of the body (2). The invention also relates to a wafer (2) provided with two-dimensional diffraction patterns (3A,3B) and a method for detecting motion of a body.

The invention relates to a system and method for detecting motion of a body. The invention further relates to a semiconductor wafer adapted to detect motion of such a wafer.

Accurate measurement of the position or position variations of moving bodies is required in various technological applications. As an example, lithographic projection tools and wafer inspection tools applied in the semiconductor industry require accurate information on position variations of semiconductor wafers. Another field of use involves the printed circuit board (PCB) industry, wherein information on the position of the PCB is required in mounting components on a PCB, printing patterns on a PCB or inspection of PCB's. Still another field of use involves position measurement and detection of motion of samples in e.g. electron microscopes.

Typically, translations or displacements of bodies are measured optically by providing incident light beams to said bodies. EP-A-0 603 905 discloses a displacement detection apparatus including a light source and a first and second diffraction grating arranged on a substrate. Light from the light source is diffracted by the first diffraction grating and the first order diffracted beams are irradiated onto the second diffraction grating. A light receiving element is provided with a third diffraction grating for synthesizing the first order diffraction beams of the second diffraction grating to convert the interference light into a signal representing a displacement of the substrate.

A disadvantage of the prior art apparatus is the limitation for rotation of the body in the plane of the diffraction pattern to enable accurate detection of the translation of the body. Rotation of the body in the plane of the diffraction pattern results in a rotation of the first order diffracted beams such that these diffracted beams do no longer accurately pass the optical systems and can no longer be appropriately detected.

It is an object of the invention to provide a system for detecting motion of a body with an increased allowable in-plane rotation range for the body.

This object is accomplished by a system for detecting motion of a body, said body comprising a first diffraction pattern and a second diffraction pattern with a predetermined orientation relative to said first diffraction pattern, wherein said system comprises:

optical means adapted to provide at least a first incident beam to said first diffraction pattern to obtain a first diffracted beam from said first diffraction pattern and at least a second incident beam, with a predetermined orientation relative to said first incident beam, to said second diffraction pattern to obtain a second diffracted beam from said second diffraction pattern;

means for detecting motion of said body on the basis of at least one of said first diffracted beam and said second diffracted beam.

As semiconductor industry constitutes an important application of the above system, it is another object of the invention to provide a semiconductor wafer adapted to be used in a system for detecting motion of such a wafer.

This object is accomplished by a semiconductor wafer with a first two-dimensional diffraction pattern and a second two-dimensional diffraction pattern arranged over said first diffraction pattern adapted to detect motion of said wafer. The diffraction patterns are preferably applied on the backside of the wafer or on a carrier to be attached to said wafer in order not to accommodate space required for processing.

It is another object of the invention to provide a method for detecting motion of a body with an increased rotation range in the plane of the diffraction grating.

This object is accomplished by a method for detecting motion of a body, said body comprising a first diffraction pattern and a second diffraction pattern with a predetermined orientation relative to said first diffraction pattern, wherein said method comprises the steps of:

providing a first incident beam to said first diffraction pattern to obtain a first diffracted beam;

providing a second incident beam to said second diffraction pattern to obtain a second diffracted beam, and

detecting motion of said body on the basis of at least one of said first diffracted beam and said second diffracted beam.

During rotation of the body, and consequently of the diffraction patterns or diffraction gratings, the direction of the first order diffracted beams may vary. As the system and method according to the invention employ at least two diffraction patterns for said body, each of said diffraction patterns arranged to be responsive to at least one of said incident beams, suitable orientation of the diffraction patterns and said optical means results in an increased in-plane rotation range for detecting motion of the body.

The embodiment of the invention as defined in claim 2 allows to employ a single sensor system for translations in the plane of the diffraction pattern.

The embodiment of the invention as defined in claim 3 and 14 has the advantage that the increased in-plane rotation range is obtained for each point common to both diffraction patterns.

The embodiment of the invention as defined in claim 4 has the advantage that the out-of-plane rotation or tilt range may be enhanced using a single sensor system.

The embodiment of the invention as defined in claims 5 and 15 has the advantage that large rotations of the body in the plane of the diffraction patterns, such as rotations of a semiconductor wafer over e.g. 90 or 180 degrees, can be detected.

The embodiment of the invention as defined in claims 6 and 16 has the advantage that the center of rotation of the body may be arbitrary.

The embodiment of the invention as defined in claims 7 and 8 has the advantage that not only displacement of the body can be detected but also information is made available on the absolute position on the body.

The embodiment of the invention as defined in claims 9 and 18 provides a suitable system for arranging said diffraction patterns one above the other. Selection of a particular diffraction grating is e.g. based on the grating period of the diffraction grating and/or the wavelength of the optical measurement system.

The embodiment of the invention as defined in claim 10 has the advantage that an optimal measurement range is obtained by arranging the measurement systems such that the relevant diffraction beam or diffraction beams for detecting motion of the body are either received by the first or the second measurement system. Accordingly, detection of one or more of the first diffracted beams can first be performed by the first measurement system, and, as the variation in the direction of these first diffracted beams due to rotation of the body makes these beams run out of this first measurement system, the second measurement system is arranged such that it receives the second diffracted beams indicative of the same motion component of the body.

The embodiment of the invention as defined in claims 11 and 19 has the advantage that translations of the body out of the plane of the diffraction patterns can be detected. A particularly interesting embodiment is defined in claims 12 and 20 that allows detection of all translations, i.e. in-plane and out-of-plane, of the body. A further embodiment of the invention is defined in claims 13 and 21. In this embodiment, all rotations of the body, both in the plane and out of the plane of the diffraction gratings, can be detected. Further, if the body rotates, this also influences the phases of the diffracted beams for measuring translation of the body. Therefore, for a body with a significant rotating motion component, the rotation should be determined to calculate the translation of the body. Accordingly, a system is obtained adapted to detect all motions of the body with an increased in-plane rotation range.

It should be appreciated that the embodiments described above, or aspects thereof, may be combined.

The invention will be further illustrated with reference to the attached drawings, which schematically show a preferred embodiment according to the invention. It will be understood that the invention is not in any way restricted to this specific and preferred embodiment.

In the drawings:

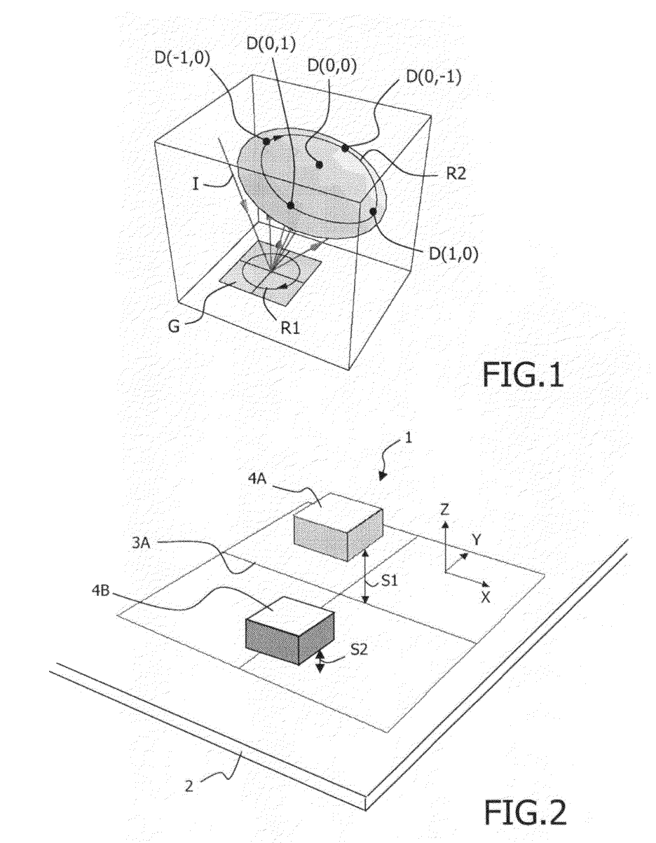

FIG. 1 illustrates the rotation of the first order diffracted beams as a consequence of in-plane rotation of a diffraction pattern;

FIG. 2 illustrates a system according to an embodiment of the invention;

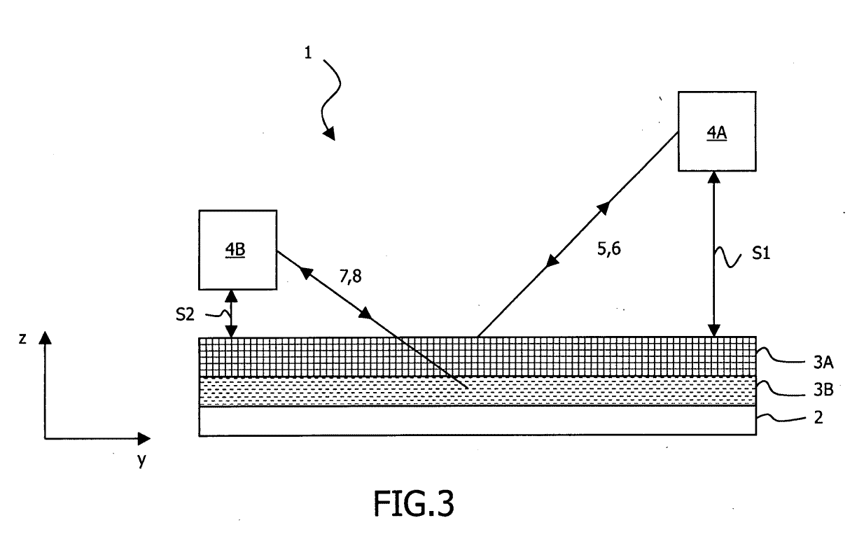

FIG. 3 displays a cross-section of the system of FIG. 2 according to an embodiment of the invention.

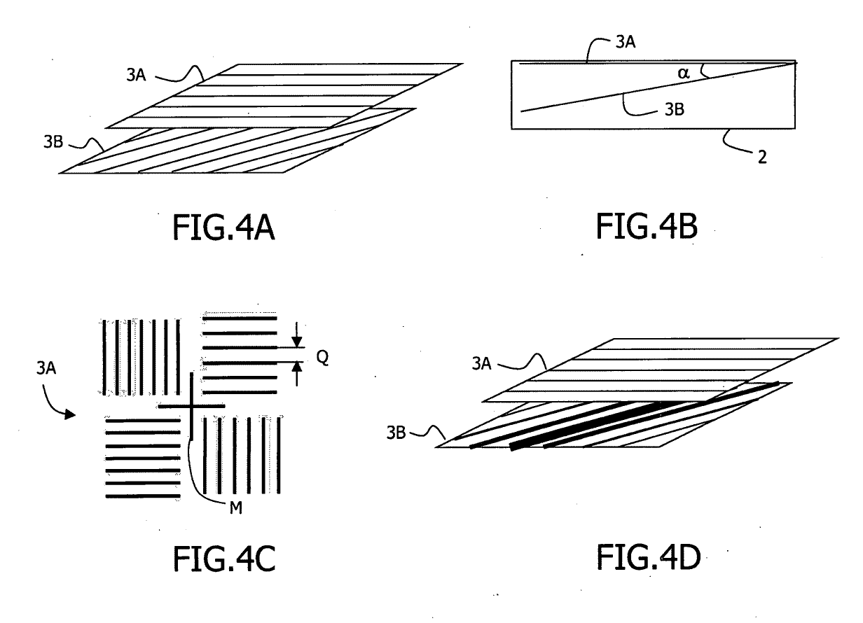

FIGS. 4A-4D display several configurations of a first and second diffraction pattern on a body according to an embodiment of the invention;

FIG. 5 shows a first example of a first and second diffraction pattern according to an embodiment of the invention;

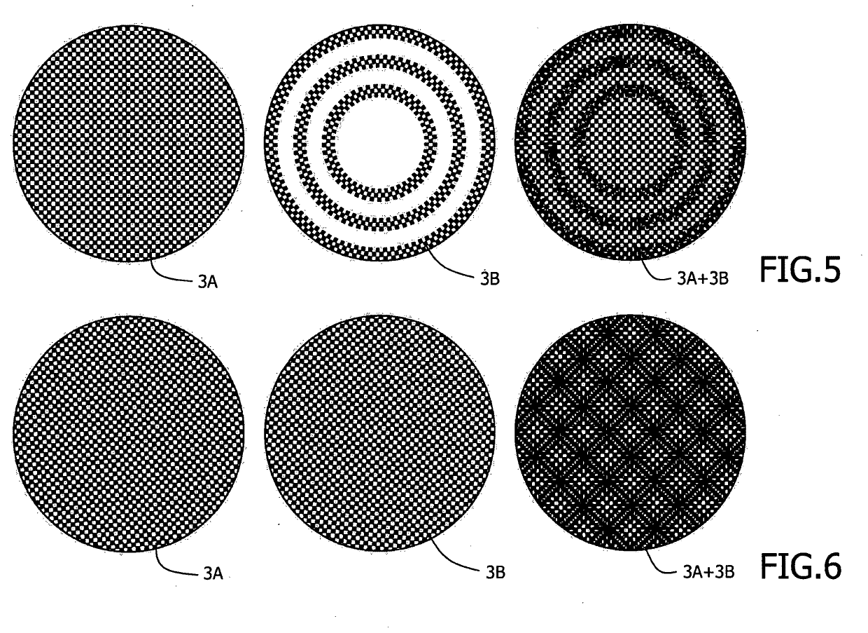

FIG. 6 shows a second example of a first and second diffraction pattern according to an embodiment of the invention;

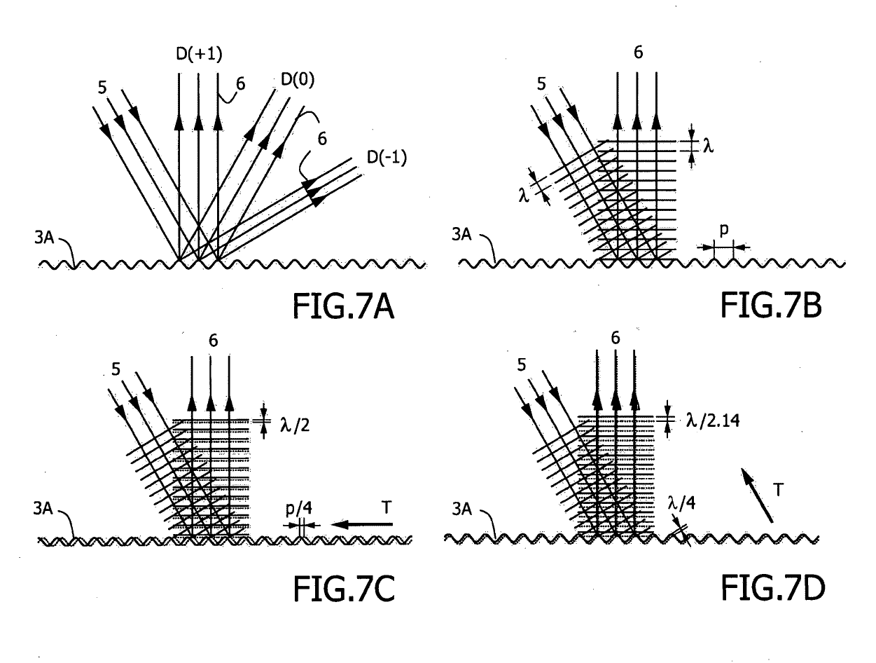

FIGS. 7A-7D show schematic illustrations of the effect of translations of a diffraction pattern on diffracted beams;

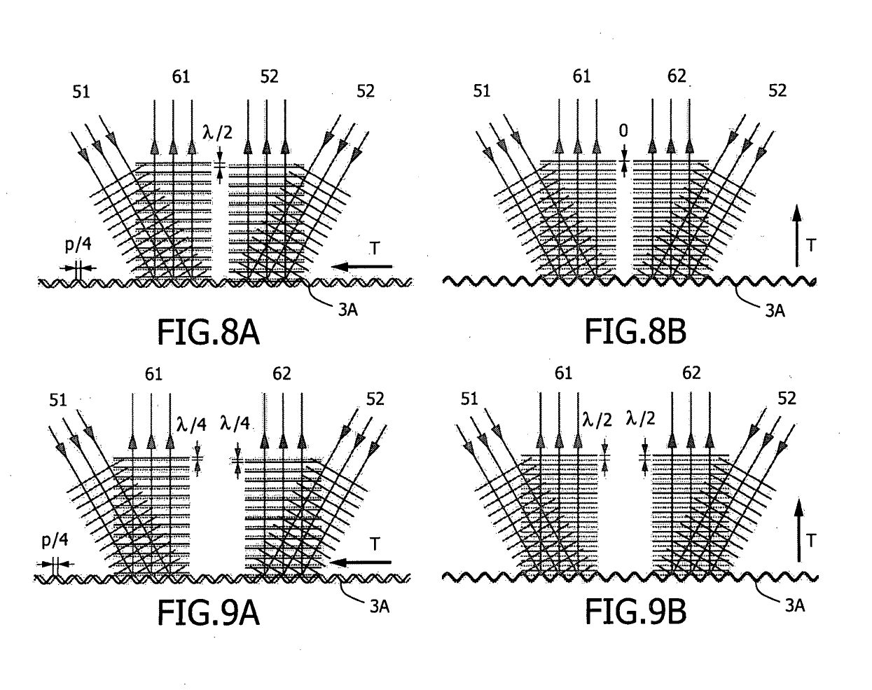

FIGS. 8A and 8B indicate a first method of measuring phase differences to detect motion of a body;

FIGS. 9A and 9B indicate a second method of measuring phase differences to detect motion of a body;

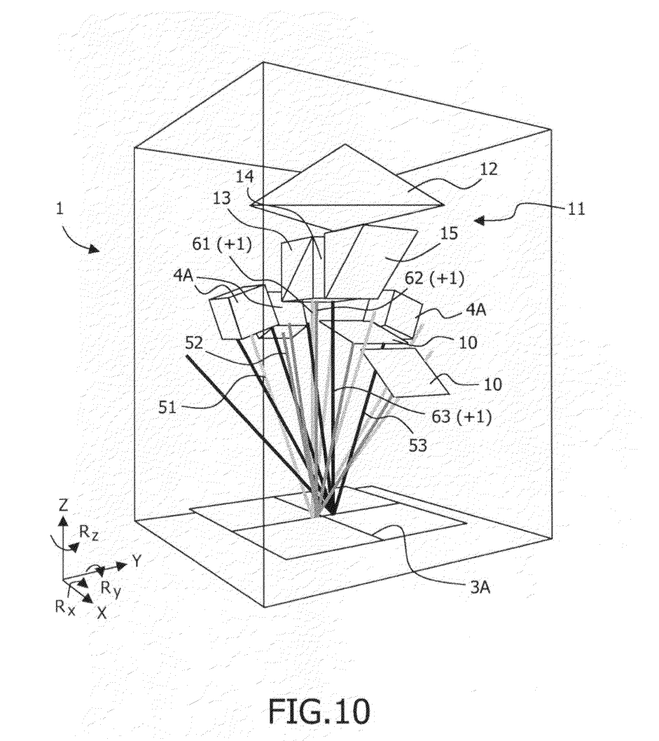

FIG. 10 schematically shows a first measurement system for detecting translations and rotation of a body according to an embodiment of the invention, and

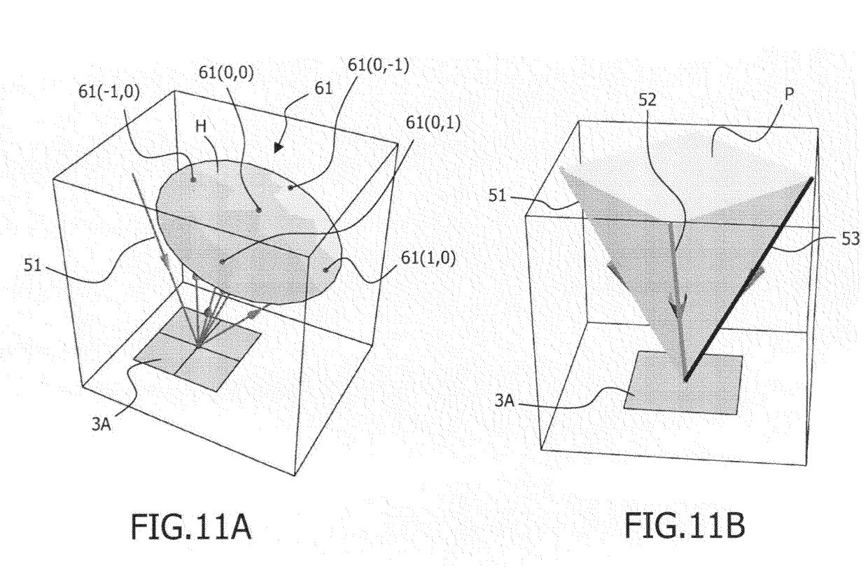

FIGS. 11A and 11B illustrate particular aspects of the system shown in FIG. 10.

FIG. 1 schematically illustrates an incident beam I directed to a two-dimensional grating G that rotates in the plane of the grating G as indicated by the arrow R1. The direction of the diffraction order D(0,0) of a diffracted beam does not vary, but, due to the rotation R of the grating G, the directions of the diffraction orders D(0,1), D(1,0), D(−1,0) and D(0,−1) vary as indicated by the arrow R2. Accordingly, systems for detecting motion of a body with such a grating G based on said diffraction orders have difficulties when such a body rotates in the plane of the grating G.

The present invention relates to a system and method to detect motion of a body that allows the body to rotate in the plane of the grating, while still enabling measurement of the diffraction orders to detect motion of said body.

FIGS. 2 and 3 schematically depict a system 1 for detecting motion of a body 2 with a first diffraction pattern 3A and a second diffraction pattern 3B, hereinafter also referred to as gratings 3A and 3B, applied to said body 2. The body 2 is e.g. a wafer or a printed circuit board The diffraction patterns 3A and 3B are provided on top of each other and the combination of diffraction patterns 3A, 3B may be directly applied to said body 2 or attached to said body 2 by means of one or more intermediate or auxiliary components (not shown). A first optical measurement system 4A, hereinafter also referred to as sensor system, is provided at a stand-off distance S1 to detect translations of the body 2 in the X, Y and Z-direction as indicated. A second optical measurement system 4B, hereinafter also referred to as sensor system, is provided with an orientation different of that of the first optical measurement system 4A with respect to the body 2 at a stand-off distance S2, different from SI.

The first optical measurement system 4A provides a first incident beam 5 to the first diffraction pattern 3A to obtain a first diffracted beam 6. The second optical measurement system 4B, with a predetermined orientation relative to said first optical measurement system 4A, for providing a second incident beam 7 to said second diffraction pattern 3B to obtain a second diffracted beam 8. The system 1 is arranged such that the diffracted beams 6, 8, or at least one diffraction order, are directed towards the measurement systems 4A and 4B respectively.

An embodiment for such a system 1 is illustrated below with reference to FIG. 10. It is noted that the measurement systems 4A and 4B may be integrated into a single optical means. As an example Heidenhain GmbH markets a two-coordinate encoder system for detecting motion of a body having a single diffraction grating attached thereto. Optical means provide two beams to said diffraction grating of said body and detect diffracted beams from said body to detect motion of the body. Another example involves the NanoGrid encoder of Optra Inc.

The first and second optical measurement system 4A, 4B comprise means for detecting motion of the body 2 on the basis of at least said first diffracted beam. Motion of the body 2 in the plane of the gratings 3A, 3B may e.g. be detected by measuring the phase difference between the first diffracted beam 6 and the second diffracted beam 8. Alternatively or in addition, the phase difference can be measured between the first incident beam 5 and the first diffracted beam 6 and/or the phase difference between the second incident beam 7 and the second diffracted beam 8. Such a system is described in detail in a co-pending patent application (“Detection system for detecting translations of a body ”) of the applicant and allows to detect motion of the body 2 out of the plane of the diffraction gratings 3A, 3B as will be further illustrated with reference to FIG. 9B.

The first grating 3A is provided on top of the second grating 3B. Such multi-layered gratings may e.g. be provided by methods known as such from manufacturing Super Audio compact discs (CD) or multi-layer digital versatile discs (DVD). Measures have been taken for the second incident beam 7 to reach the second grating 3B. As an example, the first optical measurement system 4A and/or the first diffraction grating 3A is adapted to have said first incident beam 5 select said first diffraction pattern 3A and said second optical measurement system 4B and/or said second diffraction grating 3B is adapted to have said second incident beam 7 select said second diffraction pattern 3B. Selection of a particular diffraction grating 3A, 3B is e.g. based on the grating period p (see FIG. 7B) of the diffraction grating 3A, 3B and/or the wavelength of the optical measurement systems 4A, 4B.

In operation, rotation of the body 2 in the plane of the diffraction pattern 3A, the direction of the diffracted beams 6, 8, especially the first orders thereof as indicated in FIG. 1, may vary. As the system 1 and method according to the invention employ at least two diffraction patterns 3A, 3B for said body 2, each of said diffraction patterns 3A, 3B may be arranged to be responsive to at least one of said incident beams 5,7. Suitable orientation of the diffraction patterns 3A, 3B relative to the optical means 4A, 4B results in an increased in-plane rotation range. Suitable orientation here means that the diffraction patterns and the optical means must be arranged such that the diffracted beam or diffracted beams 6,8, or at least relevant orders thereof, used for detecting motion of the body, can be received for relatively large rotations.

FIGS. 4A-4D schematically display several configurations of a first and second diffraction pattern on a body according to an embodiment of the invention.

Although FIGS. 2 and 3 show the diffraction patterns 3A, 3B as two-dimensional gratings allowing the detection of all in-plane translations of the body 2 by a single sensor system 4A or 4B, FIG. 4A displays the embodiment wherein both diffraction gratings 3A, 3B are one-dimensional, i.e. lines instead of checkerboard patterns. The diffraction gratings 3A and 3B have a predetermined orientation relative to each other, such that the lines are preferably not perpendicular.

FIG. 4B schematically displays the first diffraction pattern 3A in a first plane and the second diffraction pattern 3B in a second plane. The diffraction patterns 3A, 3B may be one-dimensional and/or two-dimensional diffraction patterns. The diffraction patterns are assembled with an angle a between them other, enabling a larger tilt range, i.e. rotation around the X and/or Y axis in FIG. 2, of the body 2 to be detected by a single measurement system 4A or 4B.

FIGS. 4C and 4D show diffraction pattern combinations with enhanced functionality with respect to the availability of absolute position information on the body 2.

In FIG. 4C only one diffraction pattern 3A is shown. The diffraction pattern 3A comprises a two sets of horizontal diffraction lines and two sets of vertical diffraction lines. The pitch Q in each set is different, such that the position of the first set of horizontal lines is generally, except for predetermined positions, out of phase with the second set of horizontal lines. The same is true for the two sets of vertical lines. The mark M is employed for visual inspection with e.g. a CCD camera.

FIG. 4D displays a first diffraction pattern 3A in combination with a diffraction pattern 3B with a modulated duty cycle. The line width of this modulated diffraction pattern 3B varies such that not only the phase but also the amplitude of the diffracted beam 8 varies when the body 2 moves. The absolute position is determined by registering the phase and the amplitude of the interference pattern at the same time. One can define a reference position as, for example, the position where the phase of the interference signal is zero (constructive interference) and where the amplitude reaches its maximum value.

FIG. 5 shows an embodiment of a first and second diffraction pattern 3A, 3B. The first diffraction pattern 3A is a rectangular diffraction pattern, whereas the second diffraction pattern 3B is a radial diffraction pattern. Is should be acknowledged that this sequence can be reversed. The right hand side pattern illustrates the combination of both diffraction patterns 3A, 3B. The combined diffraction patterns 3A, 3B enable large rotations of the body 2 in the plane of the diffraction patterns, such as rotations of a semiconductor wafer over 90, 180, 270 or 360 degrees, to detect motion of the body 2 if the optical measurement system 4A, 4B is directed to one of the concentric diffraction rings of the radial diffraction pattern.

FIG. 6 shows a second example of a first and second rectangular diffraction patterns 3A, 3B rotated relatively to each other according to an embodiment of the invention. The right hand side pattern illustrates the combination of both diffraction patterns 3A, 3B. Such a combination enables detection of translation of the body 2 for each rotation within the rotation range.

Finally, a description of a particularly advantageous embodiment of the invention will be briefly described with reference to FIGS. 7A-11D. This embodiment is described in further detail in a co-pending patent application (“Detection system for detecting translations of a body”) of the applicant that is incorporated in the present application by reference for illustration of the various components of the system 1. Accordingly, the present description will only provide the basic concept of the advantageous embodiment.

FIGS. 7A-7D show schematic illustrations of the effect of translations of the periodic reflection grating 3A. In FIG. 7A, an incident beam 5 is directed to the grating 3A. The incident light beam I is diffracted from the grating 3A, that is in rest, to form a diffracted beam 6. The diffraction orders D(−1), D(0) and D(+1) of the diffracted light beam 6 are shown. FIG. 7B shows the same situation for the first order with indications of the wavelength λ of the incident light beam 5 and the diffracted light beam 6.

FIGS. 7C and 7D respectively show the effect, indicated by the dotted lines for the situation before and the solid lines for the situation after the translation, of a translation of the grating 3A parallel to the plane of the grating 3A and with a component parallel to the normal \check{n} of the plane comprising the grating 3A. As indicated, a translation of the grating 3A affects the phase of the diffracted beam 6. In particular, an in-plane translation T for the grating 3A over a distance p/4 with p the period of the grating 3A, results in a phase shift of λ/2. An out-of-plane translation over a distance λ/4 results in a phase shift of λ/2.14. In the description below, the situation of FIG. 7D will be approximated in that a translation parallel to the normal \check{n} over a distance λ/4 results in a phase shift of λ/2 for the diffracted beam 6.

A similar description is valid for the second incident light beam 7 and the second diffracted light beam 8 obtained from the second diffraction grating 3B.

FIGS. 8A and 8B illustrate a first method of measuring phase differences ΔΦ to detect in-plane translation of the body 2. Two incident light beams 51 and 52 are provided at the grating 3A from different directions and the phase difference between the resulting diffracted light beams 61 and 62 is measured. For the in-plane translation T, depicted in FIG. 8A, the phase difference between the diffracted light beams D resulting from a translation T of p/4 is λ/2. However, an out-of-plane translation of the grating 3A, displayed in FIG. 8B, is not measured as the phase shifts of the diffracted beams 6 balance each other.

FIGS. 9A and 9B indicate the system and method for measuring phase differences ΔΦ according to a second embodiment of the invention. In contrast with the first method depicted in FIGS. 7A and 7B, the phase of each diffracted beam 6 is measured individually by measuring interference between an incident beam 51, 52 and a diffracted beam 61, 62. Accordingly, a phase shift of λ/4 is measured for each pair of incident and diffracted beams for in-plane translation and a phase shift of λ/2 is measured for each pair for out-of-plane translations. Thus, the system and method according to the invention allows detection of in-plane and out-of-plane translations. To determine both the in-plane and out-of-plane translation, the system should be arranged such that it can distinguish phase shift contributions of the in-plane and out-of-plane translations.

As an example, FIGS. 10, 11A and 11B schematically show a part of a system 1 for detecting translations T and rotation R of the body 2 (not shown) with a two-dimensional grating 3A applied to the body 2. The system 1 as displayed comprises optical heads 4A for providing first, second and third incident light beams 51, 52 and 53 from different directions to the two-dimensional grating 3A. First, second and third diffracted light beams 61, 62 and 63 result from these incident light beams 51, 52 and 53. Of the diffracted beams 61, 62 and 63 the diffraction orders −1, 0 and +1 are shown. Pairs of incident light beams 5 and diffracted beams 6 are indicated in black, dark-gray and light-gray. To be able to discern the various beam paths, the beams in FIG. 10 do not coincide at the same measurement spot, but at three different spots with a small offset between them. In reality however, the three beams will coincide at the same measurement spot. The measurement heads 4A further comprise means for measuring the phase difference ΔΦ between at least one of the pairs consisting of said first incident beam 51 and said first diffracted beam 61, said second incident beam 52 and said second diffracted beam 62 and said third incident beam 53 and said third diffracted beam 63. As long as the optical power of the diffraction orders is sufficient, every diffraction order of the diffracted beams 61, 62 and 63 can be used for measuring the phase difference ΔΦ. The wavelengths and angles of incidence of the beams I1, I2 and I3 and the period p of the grating 3A have been determined such that the diffraction orders +1 of the diffracted beams 61, 62 and 63 are used for detecting the translation T of the grating 3A with the measurement heads 4A. For clarity purposes, the lower second diffraction grating 3B and the optical measurement heads 4B to provide second incident light beams 71, 72 and 73 to obtain second diffracted light beams 81, 82 and 83 to measure phase differences between the pairs of an incident beam 7 and a diffracted beam 8 are omitted from FIGS. 10, 11A and 11B. This also holds for the further description here below. It should however be appreciated that the first optical measurement system 4A and the second optical measurement system 4B are preferably arranged with respect to each other such that rotation of the body 2 in the plane of the diffraction pattern 3A is either detected on the basis of said first diffracted beam 6 or said second diffracted beam 8. The rotation ranges of all measurement systems 4A, 4B, each of which looks at one of the gratings 3A, 3B, may be concatenated to a large rotation range.

The system 1 further comprises position sensitive detectors 10 arranged to receive further orders, in FIG. 10 the order 0 and −1, of said diffracted light beams 61, 62 and 63 to detect rotation R of said body 2. A rotation Rₓ, R_{y}, R_{z} of the grating 3A results in a displacement of these orders on the position sensitive detectors 10 and accordingly, rotation of the body 2 can be detected. If the body 2 rotates, this may also influence the phases of the diffracted beams 61, 62 and 63 for measuring translation of the body 2 as the path length for one or more light beams may vary. Therefore, for a body 2 with a significant rotating motion component Rₓ, R_{y}, R_{z}, this rotation should be determined to calculate the translation of the body.

More precisely, for a two-dimensional diffraction grating 3A, diffraction orders are indicated by two coordinates. The first order is indicated by (0,0), the first order in the x-direction by (1,0), the first order in the y-direction by (0,1) etc. In the embodiment described here, the further orders (0,0) and (−1,0) are used for measuring the rotation of the body 2. The order (0,0), also indicated in this text by order 0, is only sensitive to rotations Rₓ and R_{y}, while higher orders, here (−1,0) are sensitive to Rₓ, R_{y} and R_{z}. However, other further orders, such as (−1,−1), may be used as well. The indication hereinafter of the order by two coordinates is omitted for clarity purposes.

The diffracted +1st order beams 61, 62, 63 are directed to first redirection means 11. After passing this retro-reflector, the beams 61, 62, and 63 are directed to the grating 3A for a second time. Some of the diffracted beams are incident on the optical heads 4A and the phase of these further diffracted beams is measured for detecting a translation of the grating 3.

The diffracted orders 0 and −1 fall onto the two-dimensional position sensitive detector 10 and a one-dimensional position sensitive device, respectively. The position of the spot of diffraction order 0 is measured in two directions with the two-dimensional position sensitive detector 10, whereas the position of the −1st order beam is measured in one direction.

The three phase measurements and the three spot position measurements are used to determine the three translations and three rotations of the diffraction grating 3.

In FIG. 11A, for clarity reasons, only a single incident beam 5 is depicted with its associated diffraction beam 61 of which the orders +1, 0 and −1 are shown. Clearly, the grating period p of the diffraction grating 3A, the wavelength λ, and the angle of incidence are chosen such that the diffracted +1st order beam in the plane of incidence is directed along the normal \check{n} of the grating 3A. The spherical surface H in FIG. 11A is drawn only to show the orientation of the diffraction orders more clearly. The cross-lines in the grating 3A show the orientation of the two-dimensional diffraction grating.

The three optical heads 4A are positioned and oriented such that the three incident light beams 51, 52 and 53 are directed along three edges of a virtual pyramid P, shown in FIG. 6B. As can be seen in FIG. 10, the diffracted +1st order beams 51(+1), 52(+1) and 53(+1) in the plane of incidence of the three incident beams are parallel to each other and directed to the first redirecting means 11. This is typical for the beam layout in which the incident beams are directed along the edges of a virtual pyramid P.

The function of the first redirecting means 11, hereinafter also referred to as zero-offset retro-reflector, is to redirect an incoming beam such that the reflected beam is parallel to the incoming beam and also coincides with the incoming beam. The zero-offset retro-reflector 11 comprises a cube corner 12, a polarizing beam splitter cube 13, a half wavelength plate 14, and a prism 15 acting as folding mirror. Normally, cube corners are used as retro-reflectors. The incident and reflected beams are parallel to each other, but they are spatially separated. The zero-offset retro-reflector 11 redirects an incident beam along the same optical path back to the grating 3A. If the direction or the position of the incident beam is not nominal, then the offset between the incident and reflected beams will not be zero.

It should be noted that the above-mentioned embodiments illustrate, rather than limit, the invention, and that those skilled in the art will be able to design many alternative embodiments without departing from the scope of the appended claims. The gist of the invention relates to the insight that suitable orientation of the diffraction patterns and the measurement systems results in an increased measurement range for detecting motion of the body. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A system (1) for detecting motion of a body (2), said body comprising a first diffraction pattern (3A) and a second diffraction pattern (3B) with a predetermined orientation relative to said first diffraction pattern, wherein said system comprises:
optical means (4A, 4B) adapted to provide at least a first incident beam (5) to said first diffraction pattern to obtain a first diffracted beam (6) from said first diffraction pattern and at least a second incident beam (7), with a predetermined orientation relative to said first incident beam, to said second diffraction pattern to obtain a second diffracted beam (8) from said second diffraction pattern;
means for detecting motion of said body on the basis of at least one of said first diffracted beam and said second diffracted beam.

2. The system (1) according to claim 1, wherein at least one of said first diffraction pattern (3A) and said second diffraction pattern (3B) is a two-dimensional diffraction pattern.

3. The system (1) according to claim 1, wherein said first diffraction pattern (3A) is provided over said second diffraction grating (3B).

4. The system (1) according to claim 1, wherein said first diffraction pattern (3A) determines a first plane and said second diffraction pattern (3B) determines a second plane and wherein said first plane and second plane make an angle (α) with respect to each other.

5. The system (1) according to claim 1, wherein said first diffraction pattern (3A) and said second diffraction pattern (3B) comprise a rectangular diffraction pattern and a radial diffraction pattern.

6. The system (1) according to claim 1, wherein said first diffraction pattern (3A) and said second diffraction pattern (3B) are rectangular diffraction patterns rotated relatively to each other.

7. The system (1) according to claim 1, wherein at least one of said first diffraction pattern (3A) and said second diffraction pattern (3B) comprises lines of varying widths adapted to provide absolute position information for said body.

8. The system (1) according to claim 1, wherein said body further comprises marks adapted for visual inspection of the absolute position of said body.

9. The system (1) according to claim 1, wherein said optical means comprise a first optical measurement system (4A) and a second optical measurement system (4B), wherein said first optical measurement system and/or said first diffraction grating (3A) is adapted to allow selection of said first diffraction pattern by said first incident beam (5) and wherein said second optical measurement system (4B) and/or said second diffraction grating (3B) is adapted to allow selection of said second diffraction pattern by said second incident beam (7).

10. The system (1) according to claim 9, wherein said first optical measurement system (4A) and said second optical measurement system (4B) are arranged with respect to each other such that motion of said body (2) within a specific range is either detected on the basis of said first diffracted beam (6) or said second diffracted beam (8).

11. The system (1) according to claim 1, wherein said means (4A, 4B) for detecting motion of said body are adapted to measure a phase difference between at least one of said first incident beam (5) and said first diffracted beam (6) or said second incident beam (7) and said second diffracted beam (8).

12. The system (1) according to claim 1, wherein said optical means comprises:
means (4A;4B) for providing a first, second and third incident light beam (51,71;52,72;53,73) to said first and/or second diffraction pattern (3A,3B) from a first, second and third direction to obtain a first, second and third diffracted beam (61,81;62,82;63,83);
means (4A,4B) for measuring a phase difference between at least one of the pairs (51,61;52,62;53,63;71,81;72,82; 73,83) consisting of said first incident beam and said first diffracted beam, said second incident beam and said second diffracted beam and said third incident beam and said third diffracted beam to detect motion of said body (2).

13. The system (1) according to claim 11, wherein said system comprises position sensitive detectors (10) arranged to receive further orders (0, −1) of said diffracted light beams (61,62,63;81,82,83) to detect rotation of said body (2).

14. A semiconductor wafer (2) with a first two-dimensional diffraction pattern (3A) and a second two-dimensional diffraction pattern (3B) arranged over said first diffraction pattern adapted to detect motion of said wafer (2).

15. The wafer (2) according to claim 14, wherein said first diffraction pattern (3A) and said second diffraction pattern (3B) comprise a rectangular diffraction pattern and a radial diffraction pattern.

16. The wafer (2) according to claim 14, wherein said first diffraction pattern (3A) and said second diffraction pattern (3B) are rectangular diffraction patterns rotated relatively to each other.

17. A method for detecting motion of a body (2), said body comprising a first diffraction pattern (3A) and a second diffraction pattern (3B) with a predetermined orientation relative to said first diffraction pattern, wherein said method comprises the steps of:
providing a first incident beam (5) to said first diffraction pattern to obtain a first diffracted beam (6);
providing a second incident beam (7) to said second diffraction pattern to obtain a second diffracted beam (8), and
detecting motion of said body on the basis of at least one of said first diffracted beam and said second diffracted beam.

18. The method according to claim 17, further comprising the steps of providing said first incident beam (5) to select said first diffraction pattern (3A) and providing said second incident beam (7) to select said second diffraction pattern (3B).

19. The method according to claim 17, wherein said motion of said body (2) is detected by measuring a phase difference between at least one of said first incident beam (5) and said first diffracted beam (6) or said second incident beam (7) and said second diffracted beam (8).

20. The method according to claim 17, wherein said method comprises the steps of:
providing a first, second and third incident light beam (51,71;52,72;53,73) to said first and/or second diffraction pattern (3A,3B) from a first, second and third direction to obtain a first, second and third diffracted beam (61,81;62,82;63,83), and
measuring a phase difference between at least one of the pairs (51,61;52,62;53,63;71,81;72,82; 73,83) consisting of said first incident beam and said first diffracted beam, said second incident beam and said second diffracted beam and said third incident beam and said third diffracted beam.

21. The method according to claim 17, wherein said method further comprises the step of detecting rotation (Rₓ;R_{y};R_{z}) of said body (2) by receiving further orders (0,−1) of said diffracted beams at position sensitive detectors (10).
